(19) United States
(12) Patent Application Publication
(10) Pub. No.: US 2026/0219500 A1
(43) Pub. Date: Jul. 30, 2026

(54) DEVICE FOR PROJECTING AN IMAGE INTO THE EYE OF A USER

(71) Applicant: Commissariat à l'Energie Atomique et aux Energies Alternatives, Paris (FR)

(72) Inventors: Matthias COLARD, Grenoble Cedex 09 (FR); Christophe MARTINEZ, Grenoble Cedex 09 (FR)

(73) Assignee: Commissariat à l'Energie Atomique et aux Energies Alternatives, Paris (FR)

(21) Appl. No.: 18/724,733

(22) PCT Filed: Dec. 25, 2022
(86) PCT No.: PCT/EP2022/087839

§ 371 Date: Jun. 27, 2024

(30) Foreign Application Priority Data
Dec. 28, 2021 (FR) FR2114595

(51) Int. Cl. G02B 27/01

(52) U.S. Cl. CPC G02B 27/0172; G02B 27/0103; G02B 2027/0105; G02B 2027/0174

(57) ABSTRACT

The invention relates to a device for projecting an image onto the retina of an eye, the device having light sources and an emission medium comprising various emission points, each emission point being configured to emit light in one angular direction of propagation. The emission points are divided into various subsets of emission points, each subset of emission points emitting light in the same angular direction, so as to converge toward the same pixel of the image. The device is such that a given light source is connected to a plurality of twin emission subsets.

### TECHNICAL FIELD

The technical field of the invention relates to projection of an image onto an eye, in applications such as augmented reality.

### PRIOR ART

Wearable augmented-reality devices, such as glasses, allow a real scene to be observed while complementary information is viewed. This type of device is frequently based on micro-displays, allowing an image to be formed in immediate proximity to an eye of a user. Such micro-displays may for example be integrated into a pair of glasses. An optical system, comprising a set of lenses, allows a clear image to be perceived by the eye.

U.S. Pat. No. 9,632,317 describes a device allowing projection, onto the retina of the eye, without display or optical system. The device comprises a transparent integrated optical circuit composed of an array of nanoscale light guides, of an array of electrodes and of a holographic film. Such a device is compact, and allows a large field of view to be obtained. In addition, it makes it possible not to use bulky optical systems of complex design.

The nanoscale light guides allow a set of emission points to be defined on the holographic film, each point being capable of being illuminated by light extracted from one light guide. The set of emission points is subdivided into various emission subsets, each emission subset comprising emission points distributed, as randomly as possible, over the holographic film. The emission points of a given emission subset may be simultaneously illuminated by the various light guides. Under the effect of illumination, each emission point of the same emission subset emits a light wave that propagates in the same angular direction to the pupil of the eye, so as to form a single spot of light on the retina. In this way, each subset of emission points allows a pixel of the image perceived by the user to be formed. An image may be formed by successively illuminating various subsets of emission points, so as to form an image comprising a high number of pixels. The frequency of illumination of each subset of emission points is set so that, under the effect of persistence of vision, the user may experience a fixed image, despite the sequential formation of the various pixels of the image.

As indicated above, it is preferable, in a given subset, for the emission points to be distributed as randomly as possible, so as to avoid effects due to repetition of patterns by periodic or quasi-periodic structures during the formation of the image on the retina.

In U.S. Pat. No. 9,632,317, light is extracted from each light guide by placing, over the length of the light guide, electrically modulatable diffraction gratings. The diffraction gratings are spaced apart from one another and define discrete light-extracting regions. Under the effect of an electrical activation, each diffraction grating allows light propagating through one light guide to be extracted. In U.S. Pat. No. 9,632,317, the light guides are of sinusoidal shape, and extend parallel to one another. However, it is necessary to provide a high number of laser light sources, typically several hundred, if it is desired to achieve a sufficient number of pixels formed simultaneously on the image.

The inventors provide an optimized configuration, so as to preserve a high number of pixels, while reducing the number of laser light sources and preserving the quality of the images formed on the retina.

### SUMMARY OF THE INVENTION

A first subject of the invention is a device for projecting an image onto the retina of an eye, the image being composed of a plurality of pixels, the device comprising:
light sources, preferably laser light sources;
an emission medium, comprising:
   light guides, each light guide being connected to one light source and to a plurality of diffraction gratings distributed along the light guide, each diffraction grating being electrically modulatable with a view to extracting some of the light propagating through the light guide to which it is connected;
   electrodes, each electrode being configured to modulate diffraction gratings connected to various light guides;
   emission points, each emission point being formed level with one diffraction grating and lying between one electrode and one light guide, each emission point being configured to emit light, in an angular direction, following extraction of light propagating through the light guide;
      the device being such that:
various emission points are configured to emit light in the same angular direction, so as to converge on the retina, and thereby form a given pixel, said emission points defining an emission subset, in such a way that each emission subset corresponds to one angular direction of emission of light;
two adjacent pixels of the image are formed by two emission subsets associated with two different angular directions spaced apart by an elementary angular deviation, respectively;
   the device being characterized in that:
the same light source is connected to various light guides, said light guides defining various emission subsets, called twin subsets, configured to simultaneously form various pixels, called twin pixels, when the light source is activated, the twin emission subsets being associated with the light source;
the respective angular directions of each twin emission subset are spaced apart from one another by an angular deviation greater than or equal to a minimum angular deviation, the minimum angular deviation corresponding to k times the elementary angular deviation, k being greater than or equal to 2;
in such a way that the twin pixels, simultaneously formed on the retina, are offset by at least the minimum angular deviation.

The emission points of various twin emission subsets are preferably connected to the same electrode or to an electrode of the same group of electrodes.

According to one embodiment:
a plurality of light sources are connected to various respective light guides, so as to form various twin emission subsets, each twin emission subset being associated with the same light source;
the respective angular directions of each twin emission subset are spaced apart from one another by an angular deviation greater than the minimum angular deviation.

Preferably, the waveguides connected to a given light source, and forming a twin emission subset, are different from other waveguides connected to said light source, and forming another twin emission subset associated with the same light source.

The minimum angular deviation may be greater than or equal to 0.5° or 1°.

According to one embodiment:
the diameter or diagonal of the emission points is less than or equal to 10 μm, the minimum angular deviation being greater than 1.5;
the diameter or diagonal of the emission points is between 10 μm and 20 μm, the minimum angular deviation being greater than 0.8;
the diameter or diagonal of the emission points is greater than 20 μm, the minimum angular deviation being greater than 0.5.

Preferably, the diameter or diagonal of each emission point is greater than 5 μm.

According to one possibility:
the light guides connected to a given light source define first twin emission subsets and second twin emission subsets, so as to form first twin pixels and second twin pixels, respectively;
the emission points of each first twin emission subset are connected to first electrodes;
the emission points of each second twin emission subset are connected to second electrodes, different from the first electrodes;
the device comprises a switch, with a view to supplying either the first electrodes, or the second electrodes, so that the light emitted by the light source is extracted sequentially either by the emission points of the first emission subsets, or by the emission points of the second emission subsets, to sequentially form, in the image, the first twin pixels and the second twin pixels.

Advantageously, for at least one light source, various modulators are respectively interposed between a light source and various light guides connected to the light source, so as to modulate an intensity of the light propagating through said light guides independently for various light guides connected to the light source.

According to one possibility:
a light source is connected to N different twin emission subsets, which are configured to simultaneously form N twin pixels, where N is an integer greater than or equal to 2;
the light source is connected to N modulators, each modulator lying between the light source and the waveguides forming a given emission subset.

The number of twin emission subsets formed by at least one light source is greater than or equal to 20.

The device may comprise less than 20 different light sources to form an image, or part of an image, of at least 200 pixels by 200 pixels.

According to one embodiment, the device comprises a holographic film, subdivided into various holograms, each hologram being associated with one diffraction grating, and configured to emit the light wave, in the emission direction, under the effect of light extracted by the diffraction grating with which it is associated, each association between a hologram and a diffraction grating forming one light-emission point.

A second subject of the invention is a pair of glasses, comprising lenses, the pair of glasses comprising a device according to any one of the preceding claims, the stack being formed on at least one lens of the pair of glasses.

A third subject of the invention is a method of parameterization of a device according to the first subject of the invention, the parameterization comprising:
a) modeling a spatial noise distribution between two twin pixels, by modifying the minimum angular deviation;
b) estimating the minimum angular deviation depending on the spatial distribution.

Step b) may comprise estimating the signal-to-noise ratio depending on the minimum angular deviation.

Another subject of the invention is a device according to the first subject of the invention, the minimum angular deviation of which is parameterized using the method according to the third subject of the invention.

The invention will be better understood on reading the description of the examples of embodiment that are presented, in the remainder of the description, with reference to the figures listed below.

### FIGURES

FIGS. 1A and 1B schematically show the principle of self-focusing of emission points on a retina of a user. FIG. 1A shows a set of emission points converging toward a pixel. FIG. 1B shows another set of emission points converging toward a pixel adjacent the pixel described with reference to FIG. 1A.

FIG. 1C shows an example of a subset of emission points distributed over an emission medium.

FIG. 1D illustrates a step of recording holograms on a holographic film.

FIG. 1E illustrates a step of emitting a light wave via emission points formed on the device.

FIG. 2 corresponds to an example of a layout of light guides and electrodes.

FIG. 3A shows a model of a light wave, produced by a subset of emission points, and reaching a pixel. FIG. 3A shows the intensity of the light wave incident on the retina as a function of a position along a direction passing through the center of the pixel.

FIG. 3B corresponds to FIG. 3A, the unit of the x-axis being angular.

FIG. 3C illustrates a computation of the signal-to-noise ratio (SNR) associated with a light wave produced by an emission subset and reaching a pixel.

FIG. 4 shows pixels of an image formed on the retina of an eye, and a circular perimeter around some pixels, the diameter of which determines a minimum angular deviation between two pixels, called twin pixels, formed from emission subsets simultaneously illuminated by the same light source.

FIG. 5A shows the variation in the signal-to-noise ratio of a pixel, called the central pixel, surrounded by 4 neighboring pixels, for various configurations, as a function of the angular deviation between the central pixel and each neighboring pixel.

FIG. 5B shows images of a central pixel, surrounded by 4 neighboring pixels, for three different angular deviations between the central pixel and each neighboring pixel. In FIG. 5B, the pixels result from simultaneous illumination of emission subsets by the same light source: they are twin pixels.

FIG. 5C shows images of a central pixel, surrounded by 4 neighboring pixels, for three different angular deviations between the central pixel and each neighboring pixel. In FIG. 5C, the pixels result from illumination of emission subsets by light sources that are different from one another.

FIG. 6A schematically shows a configuration of light sources, of light guides and of electrodes allowing 16 emission subsets to be defined, each emission subset containing 4 emission points.

FIG. 6B illustrates 16 pixels able to be formed by the configuration shown in FIG. 6A.

FIG. 7A schematically shows a configuration of light sources, of light guides and of electrodes allowing 16 emission subsets to be defined, each emission subset containing 4 emission points, while reducing the number of light sources with respect to the configuration of FIG. 6A.

FIG. 7B illustrates 16 pixels able to be formed by the configuration shown in FIG. 7A.

FIG. 8A schematically shows the configuration described with reference to FIG. 7A, with simultaneous activation of both light sources and activation of half of the electrodes. FIG. 8B shows the pixels displayed by the configuration of FIG. 8A.

FIG. 9A schematically shows the configuration described in connection with FIG. 7A, with simultaneous activation of both light sources and activation of the other half of the electrodes. FIG. 9B shows the pixels displayed by the configuration of FIG. 9A.

FIG. 10 shows the variation in the signal-to-noise ratio of the image as a function of the angular deviation between a central pixel and 4 neighboring pixels, all the pixels being twin pixels. In FIG. 10, the size of each emission point has also been varied.

FIG. 11 shows an example of an arrangement of twin pixels, formed by the same light source.

FIG. 12 schematically shows a compromise between the signal-to-noise ratio of the image (left-hand y-axis) and the number of light sources used (right-hand y-axis) as a function of the angular deviation between the twin pixels (x-axis).

### DESCRIPTION OF PARTICULAR EMBODIMENTS

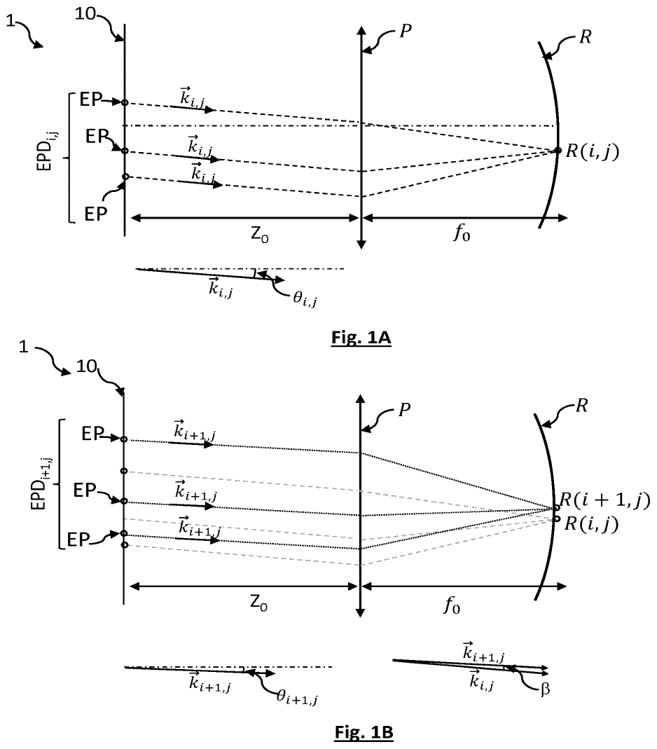

FIGS. 1A to 1E illustrate the principles on which the invention is based. These principles are described in the publication Martinez C, “See-through holographic retinal projection display concept”, Optica, Vol. 5, No. 10, October 2018. A projecting device 1 is placed facing a pupil P of an eye, said pupil focusing light onto the retina R of the eye. The projecting device comprises an emission medium 10. The emission medium 10 is formed from a set of emission points EP, each emission point being capable of being illuminated by one light source. The structure of the emission medium 10 is described with reference to FIGS. 1C and 1D. The emission medium 10 is placed at a distance Z₀ from the pupil P. The pupil P is placed at the focal length f₀ from the retina R.

Each emission point EP shown in FIG. 1A is configured to emit light in an angular direction of emission θᵢⱼ toward the pupil P. Generally, the emission points EP of the emission area are distributed into various emission subsets EPDᵢⱼ (emission point distribution) in such a way that the emission points of a given emission subset all emit light that propagates parallel to a given angular direction of emission θᵢⱼ. The angular direction of emission is defined with respect to a reference direction, for example a direction passing through the center of the pupil and perpendicular thereto. The reference direction has been represented by a dash-dotted line in FIGS. 1A and 1B.

Each emission point EP of a given emission subset EPDᵢⱼ is configured to emit, under the effect of illumination by a light source, a light wave that propagates in an angular direction of propagation θᵢⱼ toward the pupil P. The phase relationship between the various respective light waves emitted by the emission points EP of a given emission subset EPDᵢⱼ makes it possible to form, upstream of the pupil P, a plane wave, of wave vector \vec{k}ᵢⱼ or, more generally, a wave the wavefront of which is controlled. Thus, the wavefront may have a plane shape, or even a spherical or parabolic shape. Downstream of the pupil, each light wave is focused by the pupil and converges to the same pixel R(i, j) on the retina R.

The projecting device 1 thus makes it possible to form an image on the retina R, the image being discretized into a plurality of pixels R(i,j), each pixel R(i, j) corresponding to the pixel of an image formed, by the projecting device 1, on the retina R. In the example shown, the image has a square shape, and the same goes for each of its component pixels. An image may contain several hundred pixels per side.

The luminous intensity in pixel R(i, j) results from the contribution of each light wave, propagating, upstream of the pupil, in the same angular direction θᵢⱼ, resulting from each emission point EP of a given emission subset EPDᵢⱼ, after focusing by the lens. The index ij corresponds to an angular coordinate of the light wave which, after focusing by the pupil (or self-focusing), converges on the pixel R(i, j) on the retina.

The emission medium is divided into various emission subsets EPDᵢⱼ, each subset comprising a plurality of emission points EP that are distributed over the emission area, each emission subset being associated with a given angular direction of propagation θᵢⱼ, given by the wave vector \vec{k}ᵢⱼ, toward the pupil.

FIG. 1B shows another subset EPD_{i+1,j}. The emission subset EPD_{i+1,j} comprises various emission points EP, each point being associated with the same angular direction of propagation θ_{i+1,j}, given by the same wave vector \vec{k}_{i+1,j}. Downstream of the pupil, each light wave, emitted by each point of the emission subset EPD_{i+1,j}, converges to the same pixel R(i+1, j) on the retina R. The pixel R(i+1, j) is adjacent to the pixel R(i, j) shown in FIG. 1A. The angular directions θᵢⱼ, θ_{i+1,j}, which respectively allow two adjacent pixels to be formed on the retina, are spaced apart by an elementary angular deviation β. The elementary angular deviation corresponds to an angle, upstream of the pupil, between two angular directions of propagation of light waves that converge, downstream of the pupil, toward two adjacent pixels R(i+1,j), R(i, j) on the retina R. The elementary angular deviation β is typically less than 0.1° or 0.2°. It is for example equal to 0.06°.

As described in connection with the prior art, it is advantageous for the emission points EP of a given emission subset EPDᵢⱼ to be distributed pseudo-randomly over the emission medium 10. FIG. 1C shows a subset of emission points configured to emit light that propagates, toward the pupil P, parallel to the same angular direction θ_{i,j}. The emission medium lies parallel to the pupil, along an axis X and an axis Y. Each emission point EP has coordinates (x_{EP}, y_{EP}) along these axes.

FIG. 1D schematically shows the structure of the projecting device 1. The projecting device comprises the emission medium 10, the latter being connected to a plurality of light sources 21 and a plurality of switches 23. Preferably, each light source is a laser light source. Each switch allows one electrode 13 to be connected to an electrical power supply. The emission medium is formed from a plurality of transparent layers that are superposed on one another:
a first layer, in which light guides 11 are formed. Each light guide is configured to receive coherent light emitted by one laser source 21, and to propagate the coherent light along the emission medium. Each light guide may for example be formed from SiN (silicon nitride) deposited on glass. Each guide may have a thickness and width of between 200 nm and 300 nm.
a second layer, in which diffraction gratings 12 are formed, such that each diffraction grating 12 is coupled to one light guide 11. Each diffraction grating is configured to extract some of the light propagating through the light guide 11. Each diffraction grating 12 corresponds to a periodic variation in refractive index, capable of being electrically modulated. Each diffraction grating 12 may be formed from inclusions defining a periodic pattern, a Bragg grating for example, in silicon oxide (SiO₂). Each inclusion is formed from a material the refractive index of which is electrically modulatable, a liquid crystal for example. The diffraction gratings 12 coupled to a given light guide 11 are spaced apart from one another over the length of the light guide, and are considered to be discrete. When the wavelength of the light is 532 nm, the period of the pattern of the diffraction grating 12 may be between 300 nm and 400 nm. The pattern of a diffraction grating may be made up of 10 periodic features, and thus extend over a length of a few microns, between 2 and 10 μm for example.
a third layer, in which transparent electrodes 13 are formed, the electrodes being configured to electrically modulate the refractive index of a material forming the diffraction gratings. The transparent electrodes may be formed from a transparent conductive material, for example ITO (indium tin oxide). Each electrode may thus activate one diffraction grating under the effect of electrical modulation.
a fourth layer, corresponding to a holographic film 14. By holographic film, what is meant is a photosensitive medium capable of recording a hologram. The holographic film is assumed to be thin enough to be considered an emission surface. The holographic film may be a photopolymer, for example polymethyl methacrylate, or a photoresist.

The emission medium 10 is preferably formed on a plate. It may be a question of a transparent plate 15 when the device is intended to be integrated into a pair of glasses. For example, it may be a question of a glass or polycarbonate plate.

Under the effect of biasing by an electrode 13, each discrete diffraction grating 12 connected to the electrode may be activated, in the sense that it allows some of the light propagating through a light guide 11 to which it is coupled to be extracted. The extracted light propagates toward an elementary region of the holographic film 14, the elementary region storing a hologram. Under the effect of the illumination, the hologram forms an emission point EP, which emits a light wave with a predetermined wave vector k and a predetermined phase @. Thus, each diffraction grating 12, driven by one electrode 13, allows a waveguide 11 to be coupled with a hologram stored beforehand in the holographic film.

The phase of the light wave emitted by the emission point depends on the phase information stored in the hologram. The light waves emitted by various emission points EP of a given emission subset EPDᵢⱼ are out of phase with one another so that all of these light waves together form a coherent wave, of given wave vector kᵢⱼ, a plane wave for example, that propagates toward the pupil P in a given angular direction θ_{i,j}.

Thus, each emission point EP corresponds to a superposition, parallel to the emission area, of a discrete diffraction grating 12 coupled to a light guide 11, and of an electrode 13, facing a hologram of the holographic film 14.

The emission points are distributed over an emission area S. The light guides 11 are arranged parallel to the emission area S. The same goes for the electrodes 13. Thus, the electrodes 13 are superposed on the light guides 11. Parallel to the emission area S, each electrode “crosses” a plurality of light guides, so as to define a plurality of intersections, each intersection corresponding to a position of one emission point EP. The term “to cross” is to be understood to designate a superposition of an electrode and of a light guide. In FIG. 1D, for the sake of simplicity, one light guide 11 coupled to three diffraction gratings 12 have been shown, the latter being connected to three different electrodes 13, the latter being oriented perpendicular to the light guide 11.

A hologram will have been recorded on the holographic film 14 beforehand, as shown schematically in FIG. 1D. As known, a hologram is formed by interference between two light waves emitted by a coherent light source: an object light wave and a reference light wave. The interference fringes generated are physically or chemically memorized in the holographic film 14. In the recording phase, light extracted from a light guide 11 acts as reference beam. In FIG. 1D, the following have been shown:
by dashed arrows, light emitted by the laser light source and propagating through a light guide 11;
by solid arrows, light extracted from each light guide 11, by three diffraction gratings 12, respectively, under the effect of an activation by the three electrodes 13.

The object beam is a beam that propagates toward the holographic film with a wave vector \vec{k}ᵢⱼ, so as to converge on a point R(i, j) of the retina via self-focusing. In the recording step, the object beam may be emitted by a collimated source.

FIG. 1D shows three object beams propagating according to the same wave vector \vec{k}ᵢⱼ, which beams have been represented by dashed arrows. The object beams and each reference beam are emitted by the same laser light source. The recording phase consists in storing holograms, in various elementary regions of the holographic film 14, each recording resulting from interference between the object beam, which propagates according to a given wave vector \vec{k}ᵢⱼ (and therefore in a given angular direction θ_{i,j}), and one reference beam extracted from one light guide 11. During the recording:
various elementary regions of the holographic film 14 are exposed to an object beam of given wave vector \vec{k}ᵢⱼ, so as to form an emission subset EPDᵢⱼ of emission points EP corresponding to the same direction of propagation. During this exposure, the emission points of the emission subset EPDᵢⱼ are illuminated with the reference beam, the latter being extracted from the light guides. The other elementary regions of the holographic film 14, which are located facing points belonging to other emission subsets, are masked.
various elementary regions of the holographic film 14 are respectively exposed to various object beams propagating according to various wave vectors, so as to form emission points associated with different emission directions e θ_{i,j}.

FIG. 1E illustrates the phase of use of the device 1. In this figure, the elementary regions of the holographic film 14 in which a hologram was recorded in the hologram-recording step have been shown in gray. Under the effect of an activation by electrodes 13, some of the laser light propagating through the light guide 11 is extracted and propagates toward the holographic film 14, as described with reference to FIG. 1D. Under the effect of the extracted illumination, each hologram stored in the photosensitive film diffracts a wave that corresponds to the object wave at the time of recording, and in particular to the direction of propagation \vec{k}ᵢⱼ. The diffracted wave has been represented by dash-dotted arrows in FIG. 1E. During use of the device:
the emission points EP corresponding to a given emission subset EPDᵢⱼ, associated with a given wave vector \vec{k}ᵢⱼ, are activated simultaneously: coherent diffracted waves that propagate, parallel to the same propagation direction θ_{i,j}, toward the pupil P, are thus formed: the waves refracted by the pupil converge on the same pixel R(i, j) on the retina;
simultaneously, another emission subset EPD_{i′j′} may produce coherent diffracted waves that propagate toward the pupil P, in a propagation direction θ_{i′j′}, the waves refracted by the pupil converging to the same pixel R(i′, j′) in the image formed on the retina, the emission points of the emission subset EPD_{i′j′} being illuminated by light extracted from other light guides illuminated by another laser light source or the same laser light source and activated by the same group of electrodes.
emission points EP of various emission subsets EPDᵢⱼ may be activated sequentially, so as to converge sequentially toward various pixels on the retina.

The electrodes 13 and the light guides 11 are distributed in such a way as to form groups. An emission subset EPDᵢⱼ corresponds to emission points EP formed by a superposition of the electrodes of a group of electrodes on light guides of the group of light guides. Thus, each emission subset EPDᵢⱼ, forming a given pixel R(i, j), is associated with a single group of light guides 11 and with a single group of electrodes 13.

Because of persistence of vision, when the activation frequency of the various emission subsets is sufficiently high, the user perceives an image formed by the various pixels R(i,j).

The design of a projecting device such as described above is subject to size constraints: the diameter Dₚ of a pupil is considered to be of the order of 4 mm. Moreover, the emission area S is larger than the area of a pupil, and hence the eye may move with respect to the area, without degradation of the image formed on the retina being perceived.

Another requirement is with regards to the density of the emission points. Each pixel R(i, j) of the image projected onto the retina corresponds to an emission subset EPDᵢⱼ of emission points EP that is associated with a given direction of propagation θ_{i,j}. The higher the number of emission points EP contributing to the same pixel, the higher the quality of the pixel. The number of emission points EP in a given emission subset EPDᵢⱼ is preferably higher than 40, or even higher than 55 or 60.

Moreover, the number of subsets of emission points EPDᵢⱼ corresponds to the number of pixels R(i, j) formed in the image. In order to increase the number of pixels in the image formed on the retina, it is necessary to increase the number of emission subsets EPDᵢⱼ respectively associated with various directions of propagation θᵢⱼ.

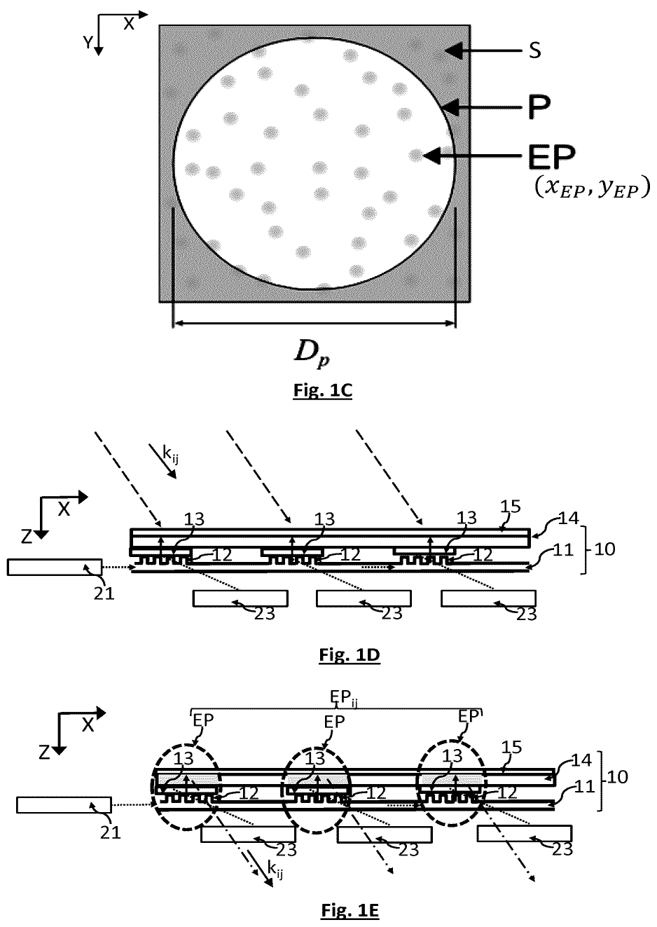

FIG. 2 illustrates an arrangement of electrodes and of light guides such as described in U.S. Pat. No. 9,632,317. In this arrangement:
the light guides 11 describe, on a surface parallel to the emission surface, sinusoidal curves, along a longitudinal axis X. Two adjacent light guides are translated with respect to each other, perpendicular to the axis X;
the electrodes 13 describe, on a surface parallel to the emission surface, sinusoidal curves, along a lateral axis Y. Two adjacent electrodes are translated with respect to each other, perpendicular to the axis Y.

The light guides are connected to laser light sources 21, laser diodes for example. The electrodes 13 are connected to switches 23. Each switch is configured to activate or deactivate each electrode to which it is connected.

Other arrangements of light guides and of electrodes are possible, for example the arrangement described in patent application FR2105017.

However, regardless of the arrangement of the light guides and electrodes, the number of different laser light sources to be used is high. For example, the device described in U.S. Pat. No. 9,632,317 comprises 400 emission subsets, each emission subset being formed by 10 waveguides. This requires the use of 400 laser light sources.

In order to reduce the number of laser light sources, the inventors propose to couple various light guides 11 to the same laser source 21, so as to simultaneously form various pixels, called twin pixels, spaced apart from one another. The intensity of the light propagating through the light guides connected to a given light source may be modulated by placing a modulator 22 between each light guide connected to the laser source. Thus, the intensity of each twin pixel may be adjusted independently. In general, the number of modulators associated with each laser light source corresponds to the number of twin pixels able to be simultaneously formed by the laser light source. To each twin pixel corresponds one emission subset, called the twin emission subset.

However, the inventors have observed that using the same laser light source to simultaneously form twin pixels may lead to the appearance of interference in the image formed on the retina. This is because the same laser light source is used to generate various coherent light waves that propagate toward various respective pixels, this potentially resulting in cross-interference.

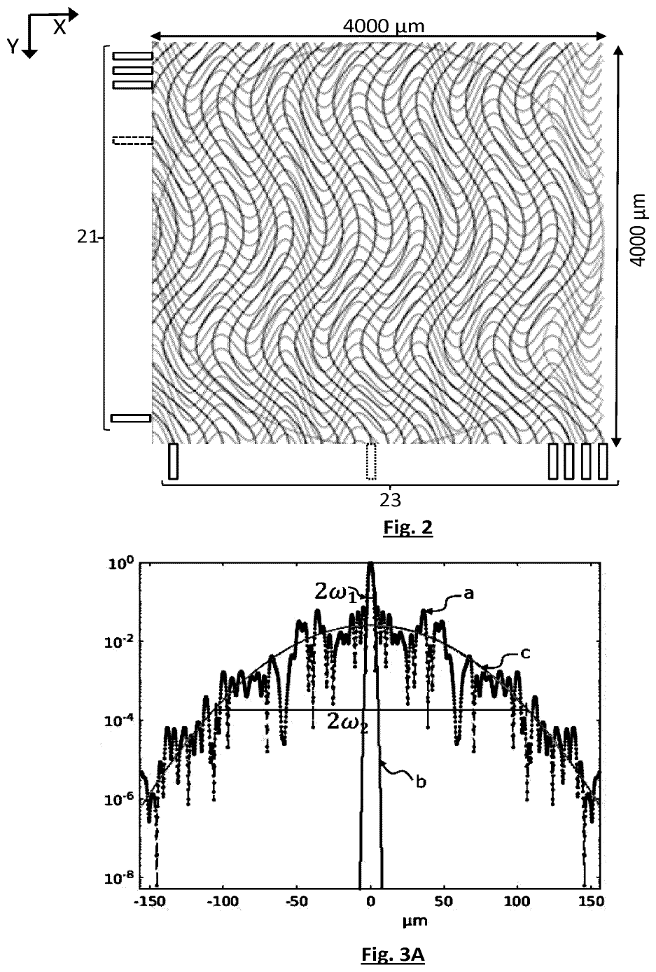

FIGS. 3A to 3C illustrate spatial intensity distributions of light waves propagating toward a pixel of the retina. Experimental studies have shown that the luminous intensity, formed by an emission subset EPDᵢⱼ, around a pixel of the retina may be modeled by a sum of two two-dimensional Gaussians:
a first two-dimensional Gaussian, of intensity I₁, and of half-waist w₁, which represents the useful signal;
a second two-dimensional Gaussian, of intensity I₂, and of half-waist w₂, which represents noise. The width w₂ is due to the effects of diffraction by the emission points EP. The smaller the latter are in size, the greater these diffraction effects.

The term “waist” corresponds to a characteristic width. It is usually a question of the width of the Gaussian corresponding to a height equal to the maximum height multiplied by e⁻².

If x designates a coordinate along a line drawn on the image projected onto the retina, centered on a pixel R(i, j), the intensity of the light produced by the emission subset EPDᵢⱼ may be expressed by the following relationship:

$$I ( x ) = {I}_{1} {e}^{- \frac{2 {x}^{2}}{{w}_{1}^{2}}} + {I}_{2} {e}^{- \frac{2 {x}^{2}}{{w}_{2}^{2}}} \qquad ( 1 )$$

with

$${w}_{1} = \frac{0.86 λ}{{D}_{p}} {f}_{0} \qquad ( 2 )$$

f₀ is the focal length of the eye;
Dₚ is the diameter or diagonal of the medium, such as shown in FIG. 1C;
λ is the wavelength.

FIG. 3A shows the intensity I(x) (y-axis) after normalization by the maximum intensity measured at the coordinate x=0, as a function of x (x-axis—unit μm). FIG. 3A shows the modeled intensity (curve a), and the two Gaussians corresponding to the useful signal and to the noise: curves b and c, respectively.

Expression (1) may be expressed as a function of an angle ψₓ with respect to a reference direction connecting the pupil to the center of the pixel. The angle ψₓ is obtained from x via:

$${ψ}_{x} = asin ( \frac{x}{{f}_{0}} ) \qquad ( 3 )$$

$$\frac{2 s i {n}^{2} ( {ψ}_{x} )}{2} I ( {ψ}_{x} ) = {I}_{1} {e}^{- \frac{2 s i {n}^{2} ( {ψ}_{x} )}{{Ω}_{1}^{2}}} + {I}_{2} {e}^{- \frac{2 s i {n}^{2} ( {ψ}_{x} )}{{Ω}_{2}^{2}}} \qquad ( 4 )$$

with

$${Ω}_{1} = \frac{0.86 λ}{{D}_{p}} \qquad ( 5 )$$

FIG. 3B shows the intensity I(ψₓ) (y-axis) after normalization by the maximum intensity modeled at the coordinate ψₓ=0, as a function of ψₓ (x-axis-degree). FIG. 3B shows the modeled intensity (curve a), and the two Gaussians corresponding to the useful signal and to the noise: curves b and c, respectively.

To establish FIGS. 3A and 3B, each emission point was considered to be a disk of 10 μm diameter.

When the same laser light source illuminates two different twin emission subsets EPDᵢⱼ, EPD_{i′j′} in order to avoid the appearance of noise in the image due to cross-interference, it is preferable for the two Gaussians modelling the noise, corresponding to the curves labelled c) in FIGS. 3A and 3B, not to overlap, or to overlap as little as possible. Thus, the angular directions θ_{i,j} θ_{i′j′} associated with the two respective twin emission subsets EPDᵢⱼ, EPD_{i′j′} are preferably spaced apart by an angular deviation Ωₘᵢₙ greater than or equal to the angle 2Ω₂, i.e. twice the half-waist of the Gaussian representative of the noise.

EPD_{i′j′} The pixels R(i, j) and R(i′, j′) defined by the two emission subsets EPDᵢⱼ, EPD_{i′j′}, respectively, are designated by the term “twin pixels”, because they are generated simultaneously by the same laser light source. The emission subsets EPDᵢⱼ, EPD_{i′j′} associated with the twin pixels R(i, j) and R(i′, j′), respectively, are called twin emission subsets. The twin pixels are spaced apart, in the image formed on the retina, by a minimum angle greater than the angle 2Ω₂, in order to avoid cross-interference. The twin emission subsets are configured to be simultaneously activated by electrodes, so as to display the twin pixels simultaneously.

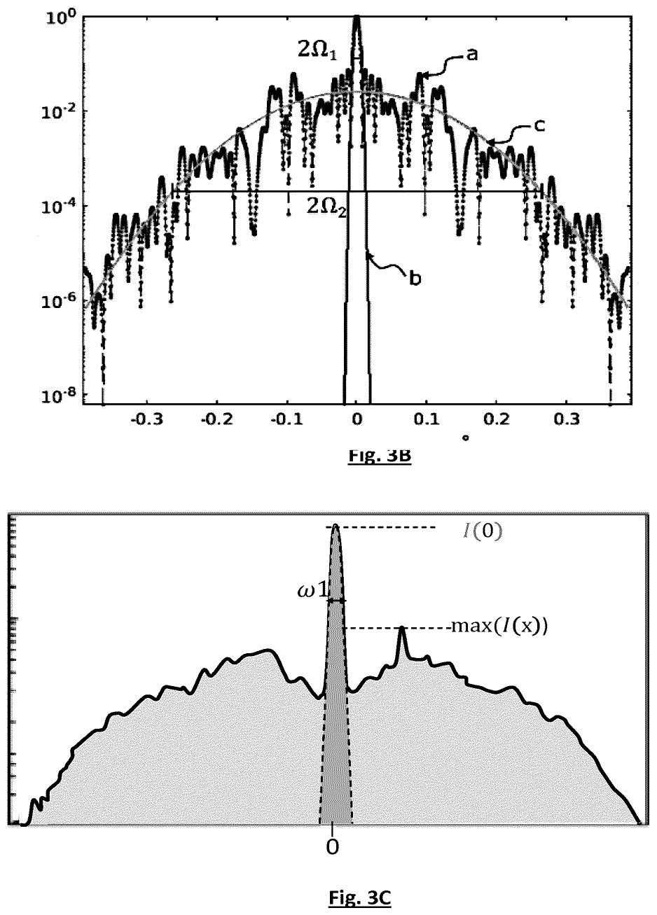

FIG. 4 illustrates projections, onto the retina, of rays from given points on the pupil P. The pixels of the image formed on the retina have been represented in the form of a grid. Four “twin” pixels have also been shown, corresponding to dark pixels. Around each twin pixel, a dashed circle has been drawn the diameter of which is equal to 2 times the half-waist w₂ of the Gaussian representative of the noise. In order to avoid overlap of two different Gaussians, representative of the noise, which would be conducive to the formation of cross-interference, the distance between two twin pixels must be greater than a minimum distance wₘᵢₙ such that wₘᵢₙ=2w₂.

The elementary angular deviation β between two adjacent pixels, which was mentioned with reference to FIG. 1B, has also been shown.

The minimum distance wₘᵢₙ may be expressed as a minimum angular deviation 2 min. Using (3), it is possible to write:

$${Ω}_{min} = asin ( \frac{{w}_{min}}{{f}_{0}} ) \qquad ( 6 )$$

The minimum angular deviation 2 min is equal to 202 with

$${Ω}_{2} = asin ( \frac{{w}_{2}}{{f}_{0}} ) \qquad ( {6}^{′} )$$

Thus, an important aspect of the invention is that two twin pixels are separated from each other by an angular deviation Ω greater than or equal to the minimum angular deviation Ωₘᵢₙ. The minimum angular deviation is defined by modeling the noise affecting the pixel when a plurality of twin pixels are formed. The minimum angular deviation is k times the elementary angular deviation β separating two adjacent pixels, where k is an integer greater than or equal to 2.

The inventors have quantified the signal-to-noise ratio associated with the intensity projected by each pixel. The projected intensity corresponds to the point spread function (PSF) of the system formed by the emission medium, the pupil and the lens. The PSF corresponds to the image of a point on the retina. FIG. 3C illustrates the PSF, in that it shows a spatial distribution of intensity on the retina. In FIG. 3C, the y-axis corresponds to the luminous intensity I(x) of the image formed on the retina and the x-axis corresponds to a distance x with respect to the origin, the origin corresponding to the center of the pixel formed on the retina.

The signal-to-noise ratio (SNR) is such that:

$$S N R = 10 {log}_{10} ( \frac{I ( 0 )}{{max}_{\vert x \vert > {w}_{1}} ( I ( x ) )} ) \qquad ( 7 )$$

I(0) is the height of the central peak;
w₁ is the half-waist of the Gaussian representative of the useful signal, described with reference to FIGS. 3A and 3B;

$${max}_{\vert x \vert > {w}_{1}} ( I ( x ) )$$

is the maximum value of the intensity outside of the central intensity peak.

The inventors have calculated the signal-to-noise ratio of a pixel obtained with an emission subset of 80 emission points spread over an emission area of 6 mm by 6 mm. In order to simulate the effect of twin pixels neighboring the modeled pixel, they assumed that each emission point EP contributing to a twin pixel formed a plane wave, the intensity of which was modulated by a Gaussian envelope, as described with reference to FIGS. 3A to 3C (Gaussian representative of noise).

The electric field of the plane wave was such that:

$$E ( x , y ) ∝ {e}^{i ( {k}_{x} x + {k}_{y} y )} {e}^{i Φ} {e}^{- \frac{{x}^{2} + {y}^{2}}{{w}_{2}^{2}}} \qquad ( 8 )$$

with

$${k}_{x} = \frac{2 π}{λ} sin ( atan ( \frac{{x}_{E P}}{{Z}_{0}} ) ) {f}_{0} \qquad ( 9 )$$

$${k}_{y} = \frac{2 π}{λ} sin ( atan ( \frac{{y}_{E P}}{{Z}_{0}} ) ) {f}_{0} \qquad ( 10 )$$

where:
x_{EP} and y_{EP} correspond to the coordinates of the emission point EP on the emission medium 10, as shown in FIG. 1C;
Z₀ is the distance between the emission medium 10 and the pupil;
x and y are coordinates on the retina, along the axes X and Y shown in FIG. 1C. It is assumed that the emission medium is parallel to the retina or may be considered as such.
Φ is a phase shift of the light wave emitted by emission point EP, this phase shift being adjusted depending on the coordinates of each emission point to ensure the wave resulting from the various emission points of a given emission subset is a plane wave.

$$Φ = \frac{2 π}{λ} ( sin ( {θ}_{x} ) {x}_{E P} + sin ( {θ}_{y} ) {y}_{E P} ) \qquad ( 11 )$$

where θₓ and θ_{y} are the components of the propagation angle θᵢⱼ with respect to the axes X and Y, respectively.

The inventors used expression (8) to simulate an image formed only by one central pixel and four neighboring pixels regularly distributed around the central pixel. By neighboring pixel, what is meant is a pixel located in the vicinity of the central pixel. It is not a question of the adjacent pixel. In order to estimate the noise in the image, the useful signal of the four neighboring pixels was removed. The background noise generated around each pixel, i.e. the central pixel and neighboring pixels, was preserved. The four neighboring pixels were placed at various distances from the central pixel.

In a first configuration, neighboring pixels formed by waves coherent with the light wave forming the central pixel were simulated. This case is representative of use of the same laser light source to illuminate each respective emission subset forming each pixel. This is the configuration according to the invention, in which it is sought to maximize the number of emission subsets illuminated by a given laser light source. It is also the least favorable configuration for formation of cross-interference.

In a second configuration, neighboring pixels formed by light waves incoherent with the light wave forming the central pixel were simulated. This case is representative of use of five different laser light sources to illuminate each respective emission subset forming each pixel. This is a reference configuration, representative of the prior art.

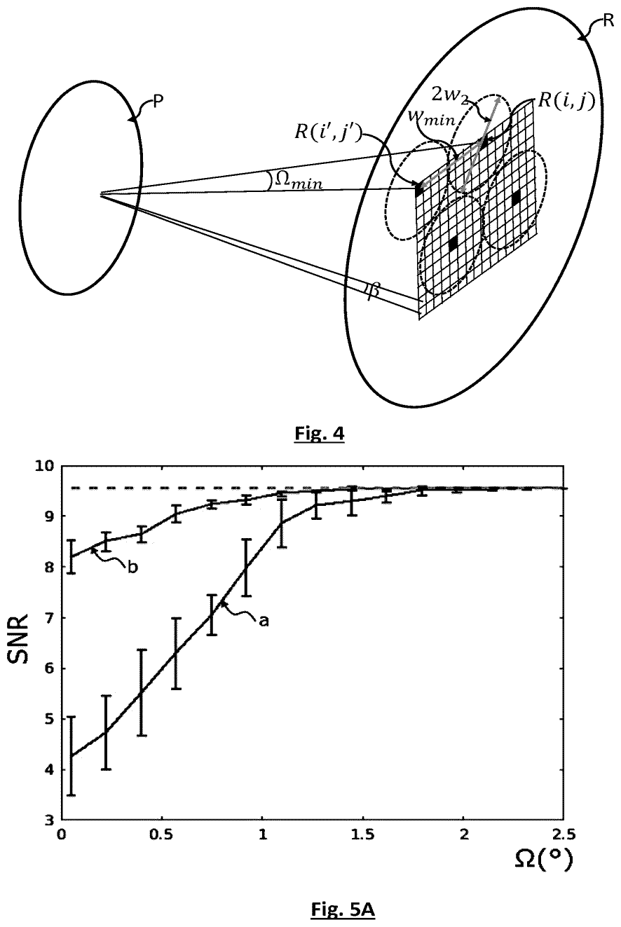

FIG. 5A shows the variation in the signal-to-noise ratio SNR such as defined in expression (7) (y-axis) as a function of the angular distance between the central pixel and each neighboring pixel (x-axis—unit degrees). Curve a) corresponds to the configuration according to the invention: the central pixel and each neighboring pixel are twin pixels. The dashed line corresponds to the signal-to-noise ratio of the central pixel with neighboring pixels not taken into account. Curve b) corresponds to the reference configuration.

FIG. 5B shows images simulated considering distances between the central pixel and neighboring pixels of 5 μm, 25 μm and 525 μm. These distances correspond to angular deviations of 0.0125°, 0.062° and 1.35°, respectively. In FIG. 5B, the configuration is the one according to the invention. The background noise and its attenuation as the distance between twin pixels increases may be seen.

FIG. 5C shows images similar to those shown in FIG. 5B, when the configuration is the reference configuration.

FIG. 5A shows that twin pixels that are too close together result in a large decrease in SNR. If the twin pixels are separated by an angle greater than 1° or even 1.5°, the impact on SNR is decreased. Beyond 2°, the impact on SNR is negligible.

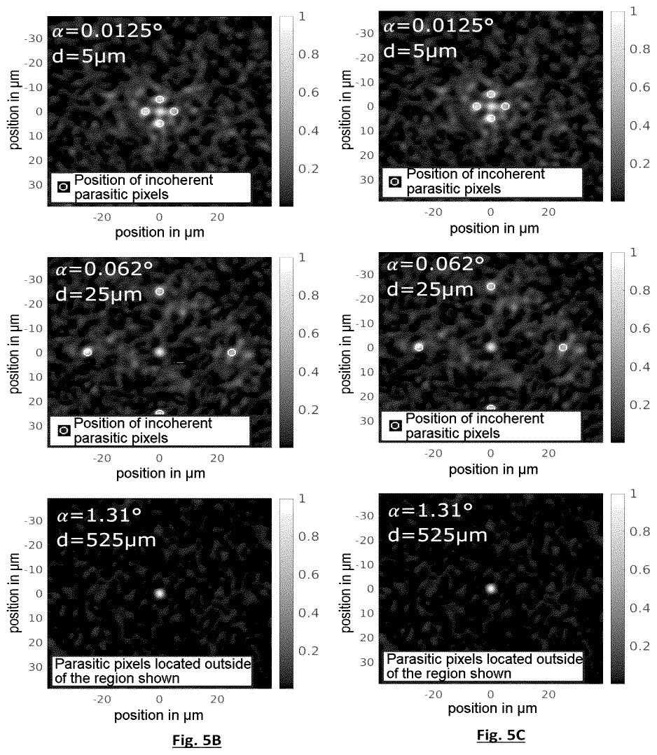

FIGS. 6A and 6B schematically show an addressing method according to the prior art. In a simplified way, these figures show light guides 11 and linear electrodes 13, the electrodes being perpendicular to the light guides. There are 16 light guides 11₁, 11₂ . . . 11₁₆ and four electrodes 13₁, 13₂, 13₃, 13₄. Each light guide is connected to one laser light source 21. Each electrode 13 is connected to one switch 23: the electrodes 13₁, 13₃ are connected to a first switch 23₁ and the electrodes 13₂, 13₄ are connected to a second switch 23₂. Both switches are turned on and connected to a power supply.

Each emission point EP, schematically represented by an oval, is placed at the intersection of a light guide and of an electrode. Each emission point is assigned a label, comprised between 1 and 16, identifying the emission subset EPD to which the emission point belongs. In this example, each emission subset EPD contains four pixels. There are 16 different emission subsets. FIG. 6B shows the 16 pixels respectively formed by the 16 emission subsets after self-focusing. Emission subsets 1 and 9 are activated when electrodes 13₁ and 13₃ are activated, and when the laser connected to the waveguides 11₁ and 11₈ is activated. The pixels formed when electrodes 13₂ and 13₄ are activated have been represented by a bold frame in FIG. 6B.

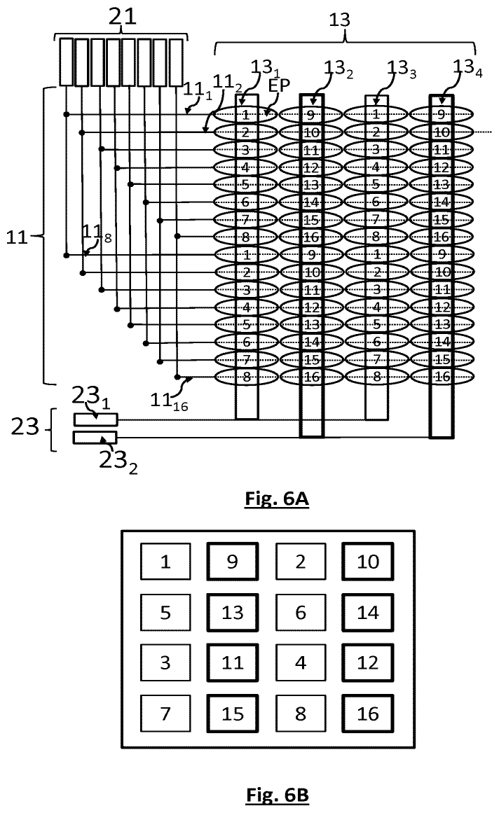

FIGS. 7A and 7B schematically show an addressing method according to the invention. Only two lasers 21₁, 21₂ are used, the latter being coupled to 8 different waveguides. The device comprises modulators 22 placed between each laser and a set of waveguides. The modulators allow the intensity of the light propagating toward each emission subset to be modulated. The intensity modulation makes it possible to form pixels of various luminous intensities with the same laser. In FIG. 7A, the shaded emission points are coupled to laser 21₂. The same is true in FIG. 7B: the shaded pixels are emitted via illumination of emission subsets by the laser 21₂.

FIG. 7B shows the pixels obtained:
following activation of laser 21₁ and of switch 23₁: this allows twin pixels 1, 2, 3 and 4, i.e. the pixels shown in white and framed by a thin line, to be displayed;
following activation of laser 21₁ and of switch 23₂: this allows twin pixels 9, 10, 11 and 12, i.e. the pixels shown in gray and framed by a thin line, to be displayed.
following activation of laser 21₂ and of switch 23₁: this allows twin pixels 5, 6, 7 and 8, i.e. the pixels shown in white and framed by a thick line, to be displayed;
following activation of laser 21₂ and of switch 23₂: this allows twin pixels 13, 14, 15 and 16, i.e. the pixels shown in gray and framed by a thick line, to be displayed.

It is thus possible to form 16 pixels using only two laser diodes.

The modulators 22 modulate the intensity of pixels 1, 2, 3, 4, 9, 10, 11 and 12, activated by the first laser 21₁, and the intensity of pixels 5, 6, 7, 8, 13, 14, 15 and 16 activated by the second laser 21₂. In order for the intensities of pixels 1, 2, 3, 4 on the one hand and 9, 10, 11, 12 on the other hand to be able to be modulated independently of one another, the power supplies 23₁ and 23₂ are activated in succession.

Pixels 1 and 9 are generated by a first emission subset, containing emission points bearing, in FIG. 7A, the label 1, and a second emission subset, containing emission points bearing, in FIG. 7A, the label 9, respectively. Emission points respectively belonging to the first and second emission subsets are formed on the same waveguides, connected to the same modulator 22. In order to be able to independently adjust the intensities of pixels 1 and 9, the first emission subset (pixel 1) is activated by first electrodes (13₁, 13₃) while the second emission subset (pixel 9) is activated by second electrodes (13₂, 13₄). Sequential activation of the first and second electrodes allows sequential display of pixels 1 and 9. This allows their respective intensities to be modulated by adjusting the modulator during each display. This aspect also applies to pixels 2 and 10, 3 and 11, 4 and 12, 5 and 13, 6 and 14, 7 and 15, and 8 and 16. Thus, use of sequential activation of various electrodes will be relevant when the emission points of various emission subsets are distributed over the same waveguides. Selection of an electrode makes it possible to activate only one emission subset on said waveguides. This allows sequential display of pixels respectively associated with emission subsets formed on common waveguides.

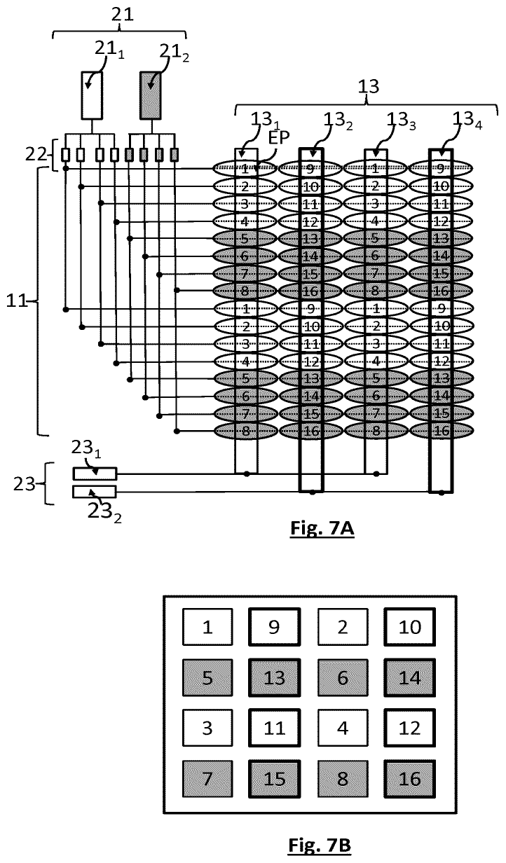

FIGS. 8A and 8B show an arrangement similar to the one described with reference to FIGS. 7A and 7B. In these figures, only the switch 23₁ is turned on: this allows simultaneous display of pixels 1, 2, 3, 4 (with the laser source 21₁) and of pixels 5, 6, 7, 8 (with the laser source 21₂). Pixels 1, 2, 3 and 4 are twins: pixels shown in white in FIG. 8B, and framed by a thin line. The same goes for pixels 5, 6, 7 and 8: pixels shown in gray in FIG. 8B, and framed by a thin line. Pixels that are not displayed have been framed by a dotted frame: it is a question of pixels 9, 10, 11, 12, 13, 14 and 15.

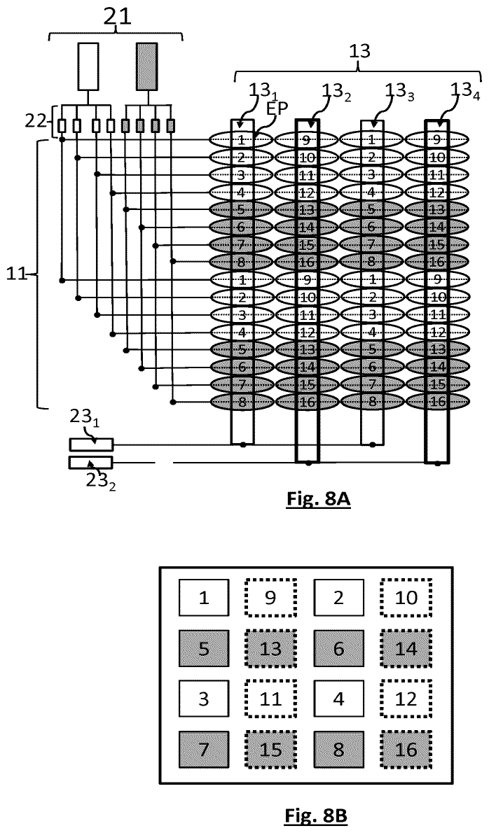

FIGS. 9A and 9B show a symmetrical configuration: only the switch 23₂ is turned on: this allows display of pixels 9, 10, 11, 12 (with the laser source 21₁) and of pixels 13, 14, 15, 16 (with the laser source 21₂). Pixels 9, 10, 11 and 12 are twins: pixels shown in white in FIG. 9B, and framed by a thick line. The same goes for pixels 13, 14, 15 and 16: pixels shown in gray in FIG. 9B and framed by a thick line. Pixels that are not displayed have been framed by a dotted frame: it is a question of pixels 1 and 8.

The configurations shown schematically in FIGS. 8A-8B and 9A-9B may be used in succession, with a repetition period high enough that, under the effect of persistence of vision, all pixels appear displayed simultaneously. The change from one configuration to the other is effected by switching the switches 23₁ and 23₂. This switching makes it possible to activate only one emission subset among various emission subsets placed on common waveguides. The emission subsets connected to the same laser light source, distributed over waveguides different from one another, and activated by common electrodes, form twin pixels: they are simultaneously activated, by the electrodes, so as to simultaneously form a plurality of pixels.

The width of the two-dimensional Gaussian w₂ representing the noise around a pixel depends on the size of the emission points EP. As the size of the emission points decreases, the effects of diffraction increase. The inventors studied the influence of the size of the emission points on SNR. To do this, they performed the modeling described with reference to FIG. 5A (curve a) for various emission-point sizes.

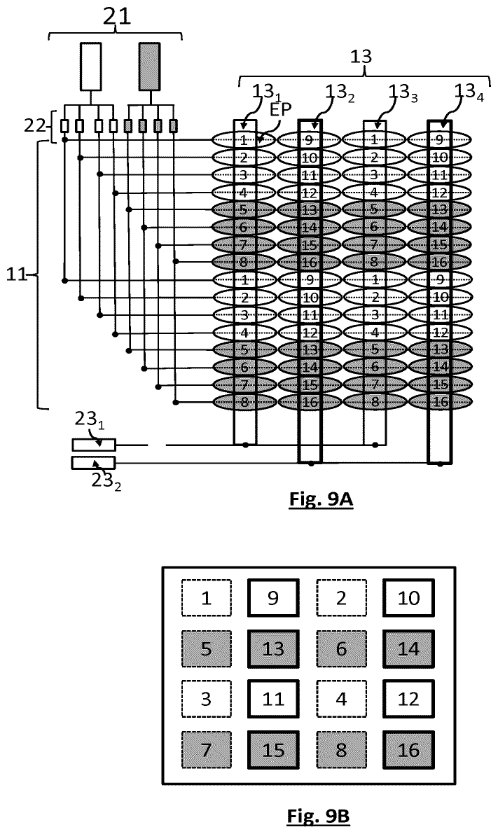

FIG. 10 shows the variation in SNR, as a function of the angular deviation between the central pixel and four twin neighboring pixels, for various sizes between 5 μm and 40 μm. The SNR obtained with a single pixel for each size has also been shown: see dashed lines. FIG. 10 was established based on disk-shaped emission points.

It may be seen that the smaller the size of the emission points, the lower the SNR. In particular, it is preferable for the size of each emission point to be greater than or equal to 10 μm when circular emission points are used.

### Example of Dimensioning

In light of the foregoing, it is possible to dimension a device 1 comprising an emission medium 10 defining a field of observation of 15°. The emission medium extends over an area of 6 mm×6 mm. Its diameter Dy is considered to be 6 mm. Each waveguide 11, of 300 nm width, is spaced apart from the next one by a period d₁₁=1.5 μm. Each electrode is spaced apart from the next one by a period d₁₃=5 μm. A number of waveguides N₁₁=9 and a number of electrodes N₁₃=9 are used per emission subset EPD.

It is thus possible to form a number of pixels Nₚᵢₓ such that

$${N}_{p i x} = ( \frac{{D}_{p}}{{d}_{11} {N}_{11}} ) ( \frac{{D}_{p}}{{d}_{13} {N}_{13}} ) \qquad ( 12 )$$

Taking into account the values indicated above, the number of pixels Nₚᵢₓ IS equal to 59000, i.e. 243×243.

Using a configuration such as shown in FIGS. 6A and 6B, the number of laser light sources would be 444.

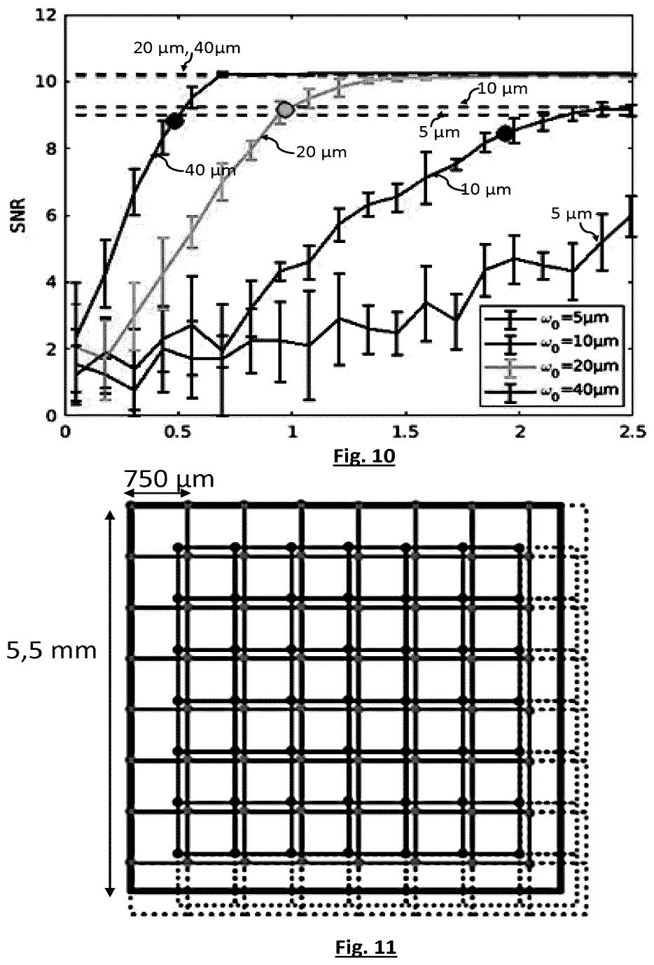

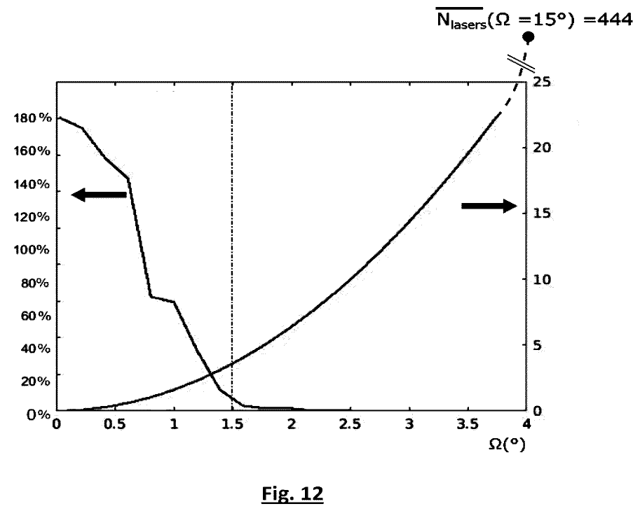

Taking into account emission points of 10 μm×10 μm size, a minimum deviation Ωₘᵢₙ=2Ω₂=1.87° is obtained, and the twin pixels may be distributed according to a square tiling, as shown in FIG. 11. A first group of twin pixels may contain 8×8 pixels, regularly distributed in a square grid with a spatial pitch of 750 μm, giving a total image width of 5.5 mm. The other groups of pixels are regularly arranged in a frame of 5.5 mm side length, either in groups of 8×8 or in groups of 7×7. This results in a total of ten groups of twin pixels, this requiring only ten laser diodes. FIG. 12 shows the first group of pixels, containing 8×8 pixels, and a second group of pixels, containing 7×7 pixels.

The number of laser light sources needed to tile the image regularly may be estimated by the expression:

$${N}_{l a s e r} ( Ω ) = {\overline{{N}_{l a s e r}} ( \frac{Ω}{FOV} )}^{2}$$

where FOV is the field of view and Ω is the angular deviation between two twin pixels. N̅ₗ̅ₐ̅ₛ̅ₑ̅ᵣ̅ is the number of lasers in the reference configuration, i.e. 444 lasers.

The lower the number of laser light sources, the higher the number of twin pixels, which, for a fixed image size, is likely to increase noise. The inventors have calculated a noise factor, which corresponds to a ratio between the noise obtained, in a configuration of one central pixel surrounded by 4 neighboring pixels, with 5 different laser sources and with the same laser source, respectively. This amounts to comparing the noise obtained in the configuration according to the invention and reference configuration described with reference to FIGS. 5A to 5C, respectively.

The noise factor is expressed by the expression:

$$η = \frac{{B}_{1} - {B}_{2}}{{B}_{2}}$$

where B₁ and B₂ are the noise amplitudes in the first configuration (invention) and the reference configuration, respectively. Each noise amplitude is such that

$$B = {max}_{\vert x \vert > {w}_{1}} ( I ( x ) )$$

in the configuration in question. This is the denominator of expression (7).

The noise factor n, expressed as a percentage, has been shown in FIG. 12: curve a: left-hand y-axis. In FIG. 12 the x-axis represents the minimum angle between twin pixels, in units of degrees. Curve b shows the number of laser light sources necessary for the system (right-hand y-axis) as a function of the angular pitch between two twin pixels (x-axis). As the angular pitch decreases, the number of light sources also decreases. It may be seen if an angular pitch between 1.5° and 2° is considered, for example 1.8 or 1.9°, that an acceptable noise factor is obtained using a reasonable number of laser sources. By reducing the angle between two twin pixels, a lower number of laser light sources may be employed, at the expense of generation of stronger cross-interference effects. By increasing the angle between two twin pixels, the effects of cross-interference are reduced, at the expense of the number of laser light sources to be used. In FIG. 12, the curve has been extended to the prior-art configuration (444 laser sources).

The invention will possibly be implemented in wearable augmented-reality devices, in particular glasses, or goggles, or screens, and more generally, on surfaces intended to be placed facing an eye so as to form an image superposed on an image that the eye perceives on the surface or through the surface.

1-15. (canceled)

16. A device for projecting an image onto a retina of an eye, the image being composed of a plurality of pixels, the device comprising:
laser light sources;
an emission medium, comprising:
light guides, each light guide being connected to one of the laser light sources and to a plurality of diffraction gratings distributed along the light guide, each diffraction grating being electrically modulatable so as to extract some of light propagating through the light guide to which it is connected;
electrodes, each electrode being configured to modulate diffraction gratings connected to various light guides;
emission points, each emission point being formed level with one diffraction grating and lying between one electrode and one light guide, each emission point being configured to emit light, in an angular direction, following extraction of light propagating through the light guide;
wherein:
various emission points are configured to emit light in a same angular direction, so as to converge on the retina, and thereby form a given pixel, the emission points defining an emission subset, in such a way that each emission subset corresponds to one angular direction of emission of light;
two adjacent pixels of the image are formed by two emission subsets associated with two different angular directions spaced apart by an elementary angular deviation, respectively;
the same laser light source is connected to various light guides, said various light guides defining various twin emission subsets, configured to simultaneously form various twin pixels when the laser light source is activated, the twin emission subsets being associated with the laser light source;
respective angular directions of each twin emission subset are spaced apart from one another by an angular deviation greater than or equal to a minimum angular deviation, the minimum angular deviation corresponding to k times the elementary angular deviation, k being greater than or equal to 2;
the twin pixels, simultaneously formed on the retina, are offset by at least the minimum angular deviation.

17. The device of claim 16, wherein the emission points of at least two twin emission subsets are connected to the same electrode.

18. The device of claim 16, wherein:
a plurality of the laser light sources are connected to various respective light guides, so as to form various twin emission subsets, each twin emission subset being associated with the same laser light source; and
the respective angular directions of each twin emission subset are spaced apart from one another by an angular deviation greater than the minimum angular deviation.

19. The device of claim 16, wherein the light guides connected to the same laser light source, and forming a twin emission subset, are different from other light guides connected to the same laser light source and forming another twin emission subset.

20. The device of claim 16, wherein the minimum angular deviation is greater than or equal to 0.5° or 1°.

21. The device of claim 16, wherein:
a diameter or diagonal of the emission points is less than or equal to 10 μm, the minimum angular deviation being greater than 1.5;
and/or the diameter or diagonal of the emission points is between 10 μm and 20 μm, the minimum angular deviation being greater than 0.8;
and/or the diameter or diagonal of the emission points is greater than 20 μm, the minimum angular deviation being greater than 0.5.

22. The device of claim 16, wherein a diameter or diagonal of each emission point is greater than 5 μm.

23. The device of claim 16, wherein:
the light guides connected to the same laser light source define first twin emission subsets and second twin emission subsets, so as to form first twin pixels and second twin pixels, respectively;
first emission points of each first twin emission subset are connected to first electrodes;
second emission points of each second twin emission subset are connected to second electrodes, different from the first electrodes; and
the device comprises a switch, configured to supply either the first electrodes, or the second electrodes, so that light emitted by the laser light source is extracted sequentially either by the first emission points of the first twin emission subsets, or by the second emission points of the second emission subsets, thereby sequentially forming, in the image, the first twin pixels and the second twin pixels.

24. The device of claim 16, wherein, for at least one laser light source of the laser light sources, various modulators are respectively interposed between the at least one laser light source and various light guides connected to the at least one laser light source, so as to modulate an intensity of the light propagating through said light guides independently for various light guides connected to the laser light source.

25. The device of claim 24, wherein:
one laser light source of the laser light sources is connected to N different twin emission subsets, which are configured to simultaneously form N twin pixels, where Nis an integer greater than or equal to 2; and
the one laser light source is connected to N modulators, each modulator lying between the one laser light source and the light guides forming a given emission subset.

26. The device of claim 16, wherein a number of twin emission subsets formed by at least one of the laser light sources is greater than or equal to 20.

27. The device of claim 16, comprising less than 20 different laser light sources to form an image, or part of an image, of at least 200 pixels by 200 pixels.

28. The device of claim 16, comprising a holographic film, subdivided into various holograms, each hologram being associated with one diffraction grating, and configured to emit light, in one of the angular directions, under an effect of light extracted by the diffraction grating with which it is associated, each association between a hologram and a diffraction grating forming one of the light emission points.

29. A pair of glasses, comprising lenses, the pair of glasses comprising the device according to claim 16, a stack being formed on at least one lens of the pair of glasses.

30. A method of parameterizing the device of claim 16, the method comprising:
a) modeling a spatial noise distribution between two twin pixels, by modifying the minimum angular deviation; and
b) estimating the minimum angular deviation depending on the spatial distribution.
